(19) United States
(12) Patent Application Publication
(10) Pub. No.: US 2019/0122231 A1
(43) Pub. Date: Apr. 25, 2019

(54) CONTAINER, NON-TRANSITORY COMPUTER-READABLE STORAGE MEDIUM FOR STORING PROGRAM, AND CUSTOMER MANAGEMENT METHOD

(71) Applicant: FUJITSU LIMITED, Kawasaki-shi (JP)

(72) Inventors: Satoshi Yoshimura, Kouto (JP); Makoto Goda, Warabi (JP); Masato Takeishi, Yokohama (JP)

(73) Assignee: FUJITSU LIMITED, Kawasaki-shi (JP)

(21) Appl. No.: 16/163,668

(22) Filed: Oct. 18, 2018

(30) Foreign Application Priority Data
Oct. 20, 2017 (JP) 2017-203737

(51) Int. Cl. G06Q 30/02; H04W 4/80; G06K 9/00

(52) U.S. Cl. CPC G06Q 30/0201; G06K 2009/00322; G06K 9/00288; H04W 4/80

(57) ABSTRACT

A container includes: a sensor configured to output a signal regarding a situation around the container; a memory; and a processor coupled to the memory, the processor being configured to execute a recognition process that includes recognizing the situation around the container in accordance with the signal from the sensor, execute a determination process that includes determining, in accordance with a result of the recognition, a group attribute to which one or more persons around the container belong, execute a registration process that includes registering the group attribute to the memory associatively with the container.

### CROSS-REFERENCE TO RELATED APPLICATION

This application is based upon and claims the benefit of priority of the prior Japanese Patent Application No. 2017-203737, filed on Oct. 20, 2017, the entire contents of which are incorporated herein by reference.

### FIELD

The embodiments discussed herein are related to a container, a non-transitory computer-readable storage medium for storing a program, and a customer management method.

### BACKGROUND

In the marketing industry, customer information is collected in order to establish a criterion of judgment in providing services and advertisements. The collection of the customer information includes collection of hobby attribute, and age and gender information based on a Web browsing history of a customer, collection of age and gender information by a visual observation of an employee at a checkout counter, collection of age and gender information by image recognition using a camera, and collection of hobby attribute based on a purchase history, and so forth. A known system is provided in which the customers are assumed to visit the store in a group when the difference between the detection time of the customer identification information of one customer and the detection time of the customer identification information of another customer belonging to the same group is within a predetermined time based on customer identification information.

Examples of the related art include Japanese Laid-open Patent Publication No. 2006-113819 Japanese Laid-open Patent Publication No. 2003-115010, and Japanese Laid-open Patent Publication No. 2004-227158.

### SUMMARY

According to an aspect of the embodiments, a container includes: a sensor configured to output a signal regarding a situation around the container; a memory; and a processor coupled to the memory, the processor being configured to execute a recognition process that includes recognizing the situation around the container in accordance with the signal from the sensor, execute a determination process that includes determining, in accordance with a result of the recognition, a group attribute to which one or more persons around the container belong, execute a registration process that includes registering the group attribute to the memory associatively with the container.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating a configuration example of a store system according to an embodiment;

FIG. 2 is a functional block diagram illustrating a configuration of an IoT container according to the embodiment;

FIG. 3 is a functional block diagram illustrating a configuration of a store management server according to the embodiment;

FIG. 4 is a diagram illustrating an example of a data structure of a container management table according to the embodiment;

FIG. 5 is a diagram illustrating an example of a data structure of a customer management table according to the embodiment;

FIG. 6 is an explanatory diagram of a flow of a process of a store system according to an embodiment;

FIG. 7 is a flowchart illustrating an example of a process of imparting a reference group attribute;

FIG. 8 is a flow chart illustrating an example of a process of imparting a reference group attribute;

FIG. 9 is a flow chart illustrating an example of a process of imparting a reference group attribute;

FIG. 10 is a diagram illustrating an example of a marker of an IoT container according to an embodiment;

FIG. 11 is a flow chart illustrating an example of a process of imparting a reference group attribute;

FIG. 12 is an explanatory diagram for describing the impartation of the reference group attribute; and

FIG. 13 is a diagram illustrating an example of a computer that executes a program.

### DESCRIPTION OF EMBODIMENTS

However, in the above-described technique, it is difficult to determine an attribute of the group, such as a family, a group of friends, a couple, and so forth, to which a customer belongs (hereinafter also referred to as a reference group attribute) and collect it as customer information. Thus, it is difficult to make marketing decisions on whether to provide a family oriented service, a couple oriented service, or others for a customer who visits as one of a group, and it is difficult to provide a service that further satisfies the customer.

According to an aspect of the present disclosure, provided is a technique of a container, a customer management method, an information processing apparatus, and so forth which is capable of collecting an attribute of the group to which a customer belongs.

Hereinafter, referring to the drawings, a customer management program, a container, a feature extraction program, a customer management method, a feature extraction method and an information processing apparatus will be described. In the embodiment, the same reference numerals are given to the components having the same function, and duplicate explanation will be omitted. The customer management program, the container, the feature extraction program, the customer management method, the feature extraction method and the information processing apparatus which are described in the following embodiments merely illustrates an example, and are not intended to limit the embodiment. The following embodiments may be appropriately combined within the consistent range.

### Structure of Store System

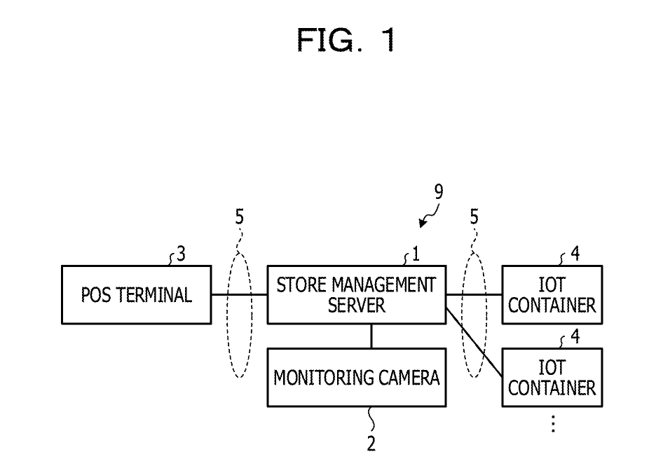

FIG. 1 is an explanatory diagram illustrating a configuration example of a store system according to an embodiment. As illustrated in FIG. 1, a store system 9 in the store includes a store management server 1, a monitoring camera 2, a POS terminal 3 (POS: Point of Sales) and an IoT container 4 (IoT: Internet of Things).

The store management server 1 manages store information and is an example of an information processing apparatus. For example, the store management server 1 manages customer information of customers using the store. The store management server 1 manages information of the IoT container 4 which is an example of an article used by a customer.

For example, the store management server 1 performs management by associating identification information of the IoT container 4 (IoT container ID) with identification information of the customer (visiting customer ID), when settlement of goods (such as beverages) purchased by the customer is performed by the POS terminal 3, and the customer starts using the IoT container 4. The store management server 1 specifies the circumstances around the IoT container 4 using the sensor mounted in the IoT container 4 and the monitoring camera 2 installed in the store. Next, the store management server 1 determines, based on the situation around the identified IoT container 4, the attribute of the group (reference group attribute) to which the customer associated with the IoT container 4 belongs, and stores the determination result which is included in the customer information.

The monitoring camera 2, which is a digital camera installed in the store, transmits a captured moving image or an intermittently captured still image (hereinafter referred to as captured image) to the store management server 1 as detection information detected by the monitoring camera 2. As described above, the monitoring camera 2 is an example of an imaging apparatus installed in a store and imaging the inside of the store.

The POS terminal 3 identifies the customer information of the customer who visits the store, and settles the transaction of the goods (for example, beverage) purchased by the customer. For example, the POS terminal 3 reads a store-specific prepaid card presented by the customer or a barcode of the store-specific application screen displayed on the mobile application of the portable terminal possessed by the customer, and identifies the customer information (visiting customer ID (IDentifier)) of the customer. The POS terminal 3 settles the transaction of the beverage purchased by the customer with respect to the customer information. In order to associate the customer with the IoT container 4, which is the container of the beverage purchased by the customer, the POS terminal 3 reads identification information of the IoT container 4 (IoT container ID) presented by a barcode or the like attached to the IoT container 4 through a scanner or the like. Next, the POS terminal 3 transmits to the store management server 1 the identification information of the IoT container 4 (IoT container ID) which has been read, and the customer information of the customer (visiting customer ID). The POS terminal 3 stores in a storage unit (not illustrated) the settlement information of after settlement. The settlement information includes, for example, customer information of the customer, trade name, price, purchase time, and so forth.

The IoT container 4 is an article lent by the store to a customer who purchased the goods, and is used by the customer during rental of the IoT container 4. For example, the IoT container 4 is a beverage container including a mug or a tumbler. The store provides the customer with goods (for example, a beverage) purchased by the customer by containing the goods in the IoT container 4, and receives the IoT container 4 after use from the customer.

The IoT container 4 has a detection function of a sensor and so forth and a communication function. For example, the IoT container 4 determines, based on the detection result by the detection function of the sensor and so forth, whether the IoT container 4 is placed on a table or the like. When it is determined that the IoT container 4 is placed on the table, the IoT container 4 notifies the store management server 1 of the surrounding situation indicated by the detection result as detection information together with its own identification information which has been set in a memory or the like.

The IoT container 4 is a container having a marker such as a barcode so as to distinguish it from another IoT container 4. Such a marker may be displayed on the display function or may be attached to the side of the container. The marker corresponds to an IoT container ID to be described later.

The IoT container 4 is described as a beverage container including a mug or a tumbler. The IoT container 4 is not limited thereto, and may be a food container. The IoT container 4 may be a container with a handle or a container without a handle. For example, the IoT container 4 may be a combination of a container and a container holder, and the container holder may have a configuration having various functions.

The store management server 1 is communicably connected to the POS terminal 3 and the IoT container 4 via a network 5. The store management server 1 is communicably connected to the monitoring camera 2 via the network 5 or a communication cable. The network 5 referred to here is, for example, WiFi (registered trademark). The network 5 is not limited to this, and may be another communication network such as a carrier network. The IoT containers 4 communicate with each other by short-distance wireless communication. The IoT container 4 is an example of a short-distance wireless communication device. The short-distance wireless communication referred to here is Bluetooth (registered trademark) such as Bluetooth Low Energy (BLE), for example. However, the short-distance wireless communication is not limited the Bluetooth. The short-distance wireless communication may be any communication standard as long as it is capable of performing communication within a distance of about several meters to several tens of meters in a store.

### Configuration of IoT Container 4

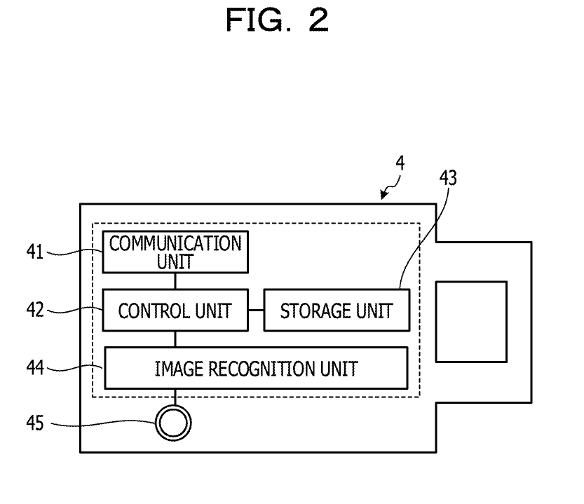

FIG. 2 is a functional block diagram illustrating the configuration of the IoT container 4 according to the embodiment. In FIG. 2, the inside of the dotted line frame illustrates the functional configuration inside the IoT container 4.

As illustrated in FIG. 2, the IoT container 4 includes a communication unit 41, a control unit 42, a storage unit 43, an image recognition unit 44, and a camera 45.

The communication unit 41 communicates with the store management server 1 via the network 5 (see FIG. 1). For example, the communication unit 41 outputs, under the control of the control unit 42, the content stored in the storage unit 43 together with its own identification information (IoT container ID) which has been set in the internal memory to the store management server 1. The communication unit 41 is an example of an output unit.

The communication unit 41 communicates with another IoT container 4 via short-distance wireless communication. The communication unit 41 is implemented by, for example, a network interface card (NIC) or the like.

The control unit 42 centrally controls the operation in the IoT container 4. For example, the control unit 42 corresponds to an electronic circuit such as a central processing unit (CPU). The control unit 42 has an internal memory for storing programs defining various processing procedures and control data, and executes various processing using these programs and data.

For example, the control unit 42 stores in the storage unit 43 the communication result of the short-distance wireless communication in the communication unit 41, the image captured by the camera 45, and the recognition result by the image recognition unit 44. Next, the control unit 42 notifies the store management server 1 of the content stored in the storage unit 43, for example, the detection information together with its own identification information (IoT container ID) which has been set in the internal memory via the communication unit 41.

The storage unit 43 is a storage device such as a random access memory (RAM), a flash memory, and so forth, and stores various pieces of information.

The image recognition unit 44 performs image recognition of the image captured by the camera 45, and outputs the recognition result together with the captured image to the control unit 42. For example, the image recognition unit 44 recognizes an object (table, person) included in the captured image by using a known image recognition technique. As an example, when a plate-like object is reflected on the bottom of the captured image, the image recognition unit 44 recognizes the object as a table. The image recognition unit 44 identifies a person region matching the shape of the person's face and so forth from the captured image, and acquires the recognition result such as the number of persons, age and gender included in the person region by analyzing the identified person region.

The camera 45 is a digital camera that images the periphery of the IoT container 4, and is an example of an imaging apparatus. For example, the camera 45 images the situation around the IoT container 4 via a fisheye lens or the like. The camera 45 outputs the captured image to the image recognition unit 44

### Configuration of Store Management Server 1

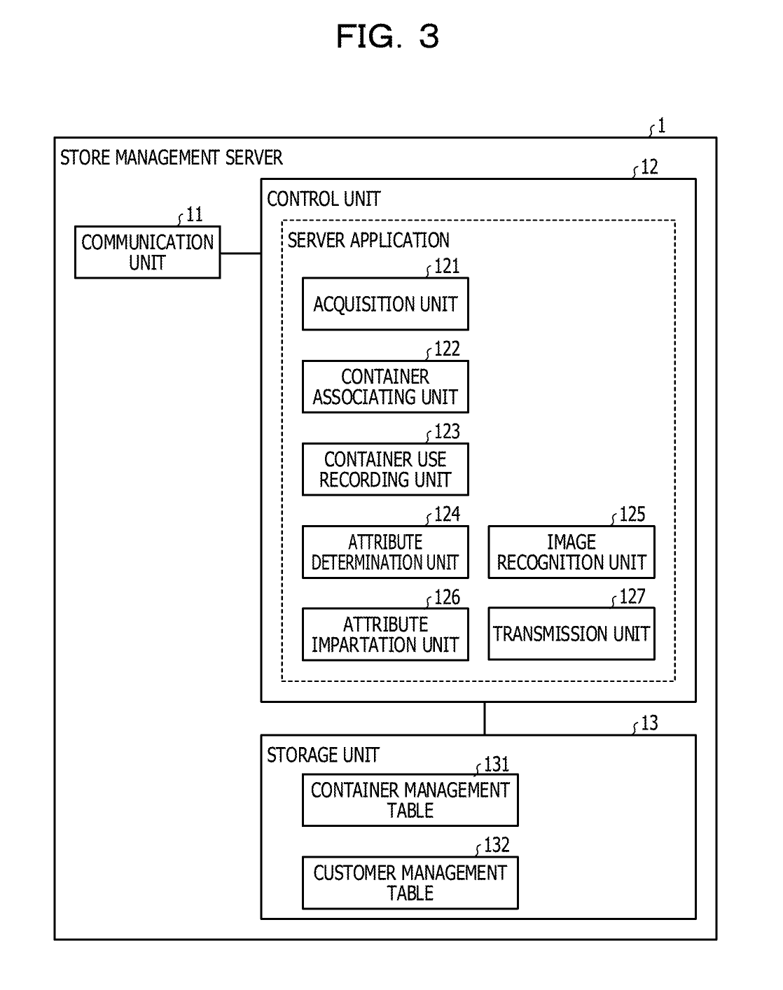

FIG. 3 is a functional block diagram illustrating a configuration of the store management server 1 according to the embodiment. As illustrated in FIG. 3, the store management server 1 includes a communication unit 11, a control unit 12, and a storage unit 13.

The communication unit 11 communicates with the POS terminal 3 and the IoT container 4 via the network 5 (see FIG. 1). The communication unit 11 receives a captured image transmitted from the monitoring camera 2 via a communication cable (not illustrated) or the network 5. The communication unit 11 is implemented by, for example, an NIC or the like.

The control unit 12 corresponds to an electronic circuit such as a CPU. The control unit 12 has an internal memory for storing programs defining various processing procedures and control data, and executes various processing using these programs and data. The control unit 12 executes processing using the server application. The control unit 12 includes an acquisition unit 121, a container associating unit 122, a container use recording unit 123, an attribute determination unit 124, an image recognition unit 125, an attribute impartation unit 126, and a transmission unit 127.

The storage unit 13 is, for example, a semiconductor memory device such as a random access memory (RAM), a flash memory, and so forth, or a storage device such as a hard disk or an optical disk. The storage unit 13 has a container management table 131 and a customer management table 132.

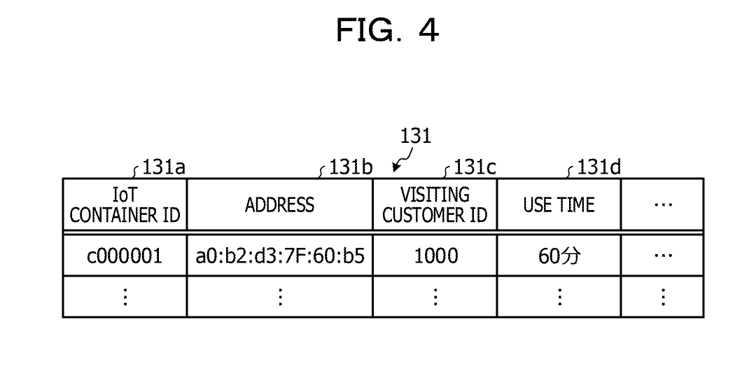

The container management table 131 manages information of each IoT container 4. The data structure of the container management table 131 will be described with reference to FIG. 4.

FIG. 4 is a diagram illustrating an example of the data structure of the container management table 131 according to the embodiment. As illustrated in FIG. 4, in the container management table 131, an IoT container ID 131a, an address 131b, a visiting customer ID 131c, and a use time 131d are stored in association with each other. The IoT container ID 131a indicates identification information of the IoT container 4 or the control unit 42 of the IoT container 4. The address 131b indicates the address of the IoT container 4. The address 131b is, for example, a media access control (MAC) address. The address 131b is not limited thereto, and may be an address indicating the destination of the IoT container 4. The visiting customer ID 131c indicates the customer information of the customer assigned to each customer. The customer information referred to here is, for example, information indicating a store-specific prepaid card or a barcode of a store-specific application screen. The use time 131d indicates the time when the customer uses the IoT container 4.

As an example, when the IoT container ID 131a is “c000001”, “a0: b2: d3: 7F: 60: b5” as the address 131b and “1000” as the visiting customer ID 131c are stored.

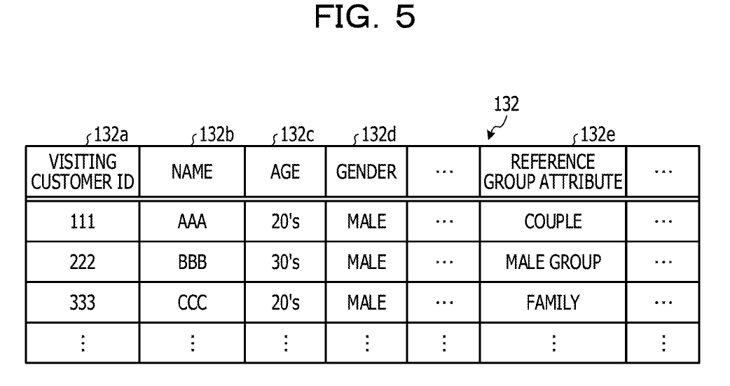

Returning to FIG. 3, the customer management table 132 manages information of each customer. The data structure of the customer management table 132 will be described with reference to FIG. 5.

FIG. 5 is a diagram illustrating an example of the data structure of the customer management table 132 according to the embodiment. As illustrated in FIG. 5, in the customer management table 132, a visiting customer ID 132a, a name 132b, an age 132c, a gender 132d, and a reference group attribute 132e are stored in association with each other. The IoT container ID 131a is identification information assigned to each customer, and, for example, is information indicating a store-specific prepaid card or a barcode of a store-specific application screen. The visiting customer ID 132a in the customer management table 132 corresponds to the visiting customer ID 131c of the container management table 131. The name 132b indicates the name of the customer. The age 132c indicates the age of the customer (age group). The gender 132d indicates the gender of the customer. The reference group attribute 132e indicates an attribute of the group to which the customer belongs, such as a family, a couple, and so forth.

For example, for a customer whose visiting customer ID 132a is “111”, ““Mr. AAA”” as the name 132b, “20's” as the age 132c, “male” as the gender 132d, and “couple” as the reference group attribute 132e are stored. The customer information managed for each visiting customer ID 132a in the customer management table 132 is not limited to the above elements (name 132b, age 132c, gender 132d, and reference group attribute 132e). For example, the customer management table 132 may include information such as the customer's address, workplace, and so forth.

Returning to FIG. 3, the acquisition unit 121 acquires information output from the monitoring camera 2, the POS terminal 3, and the IoT container 4 via the communication unit 11.

For example, the acquisition unit 121 acquires an image captured by the monitoring camera 2, that is, detection information detected by the monitoring camera 2. The acquisition unit 121 acquires identification information of the IoT container 4 (IoT container ID) read by the POS terminal 3 at the time of settlement and customer information of the customer (visiting customer ID). The acquisition unit 121 acquires the storage content of the storage unit 43 output by the IoT container 4, for example, the detection information detected by the POS terminal 3 (The communication result of the short-distance wireless communication in the communication unit 41, the image captured by the camera 45 and the recognition result by the image recognition unit 44).

When use of the IoT container 4 is started by selling the goods to the customer, or when the purchase is completed (after settlement), the container associating unit 122 associates the IoT container 4 with the customer.

For example, when the container associating unit 122 acquires identification information of the IoT container 4 from the POS terminal 3 at the time of settlement, the container associating unit 122 performs the following processing. When the acquired identification information is not stored in the IoT container ID 131a of the container management table 131, the container associating unit 122 determines that it is the timing at which use of the container indicated by the identification information is started. The container associating unit 122 stores, in the container management table 131, identification information acquired as the IoT container ID 131a, an address corresponding to the identification information as the address 131b and “0” as the use time 131d in association with each other. The address corresponding to the identification information may be held in advance in the address table.

When the container associating unit 122 acquires customer information of the customer from the POS terminal 3 after settlement, the container associating unit 122 stores the customer information in the visiting customer ID 131c corresponding to the IoT container ID 131a which is currently stored in the container management table 131. This makes it possible for the container associating unit 122 to associate the IoT container 4 with the customer. The timing to acquire the customer information of the customer may be either the timing when use of the IoT container 4 is started or the timing when the purchase is completed.

The container use recording unit 123 records the lapse of time from the timing when use of the IoT container 4 is started. For example, the container use recording unit 123 activates a timer from the timing when use of the IoT container 4 is started. The container use recording unit 123 updates the use time 131d corresponding to the IoT container ID 131a in the container management table 131.

The attribute determination unit 124 determines the reference group attribute to which the customer associated with the IoT container 4 belongs based on the situation around the IoT container 4 indicated by the information detected by the monitoring camera 2 or the IoT container 4 wherein the detection information is acquired by the acquisition unit 121. The attribute impartation unit 126 associates the determination result by the attribute determination unit 124 with the customer corresponding to the IoT container 4 to impart the determination result to the reference group attribute 132e in the customer management table 132, and to store the imparted reference group attribute 132e in the storage unit 13. Details of the processing of the attribute determination unit 124 and the attribute impartation unit 126 will be described later.

The image recognition unit 125 performs image recognition of the captured image acquired by the acquisition unit 121 from the monitoring camera 2 or the IoT container 4. Image recognition performed by the image recognition unit 125 is similar to that performed by the image recognition unit 44. The image recognition unit 125 recognizes an object (table, person) included in the captured image. From the image captured by the monitoring camera 2, the image recognition unit 125 performs image recognition for identifying the IoT container 4 included in the captured image. For example, the image recognition unit 125 identifies the IoT container 4 from the image captured by the monitoring camera 2 using a known image recognition technique, and reads the marker portion attached to the IoT container 4. Next, the image recognition unit 125 decodes the read marker or the like, and acquires identification information of the IoT container 4 (IoT container ID) corresponding to the marker.

The transmission unit 127 transmits a message to the destination corresponding to the customer in accordance with the attribute information (couple, family . . . ) imparted to the reference group attribute 132e in the customer management table 132 for the customer corresponding to the IoT container 4. For example, when the reference group attribute 132e is “couple”, the transmission unit 127 transmits a message for couple set in advance (discount service targeting a couple and so forth) to the destination corresponding to the customer.

The destination corresponding to the customer may be the mail address of the customer set in advance in the customer management table 132, or may be the address 131b associated with the visiting customer ID 131c in the container management table 131. For example, when the IoT container 4 has a display unit such as electronic paper displaying the message coming from the store management server 1, it is possible to display the message on the display portion of the IoT container 4 used by the customer by transmitting a message to the address 131b associated with the visiting customer ID 131c.

### Processing Sequence of Store System 9

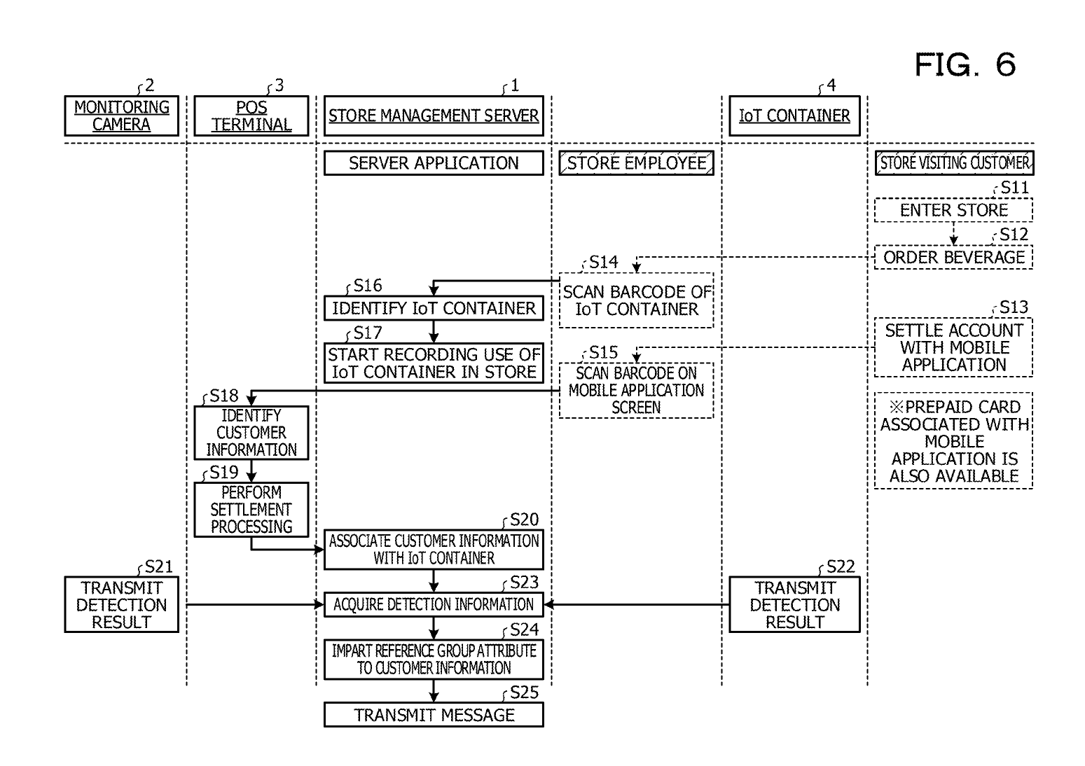

FIG. 6 is an explanatory diagram of a flow of a process of the store system 9 according to the embodiment. The broken line in FIG. 6 is a process performed by a human.

As illustrated in FIG. 6, a visiting customer (customer) enter the store and order a beverage (S11, S12). The visiting customer settles an account with a mobile application installed in a portable terminal such as a smartphone possessed by the customer (S13). The settlement may be carried out by a prepaid card cooperated with the mobile application instead of the mobile application, or may be cash settlement.

The employee of the store that accepted the order of the beverage scans the barcode (marker) attached to the IoT container 4 using the POS terminal 3 (S14). The barcode read from the IoT container 4 is the identification information of the IoT container 4 (IoT container ID). The employee scans the barcode of the mobile application screen using the POS terminal 3 (S15). The barcode read from the mobile application screen is the customer information of the visiting customer (visiting customer ID).

The store management server 1 acquires the barcode from the POS terminal 3 and identifies the IoT container 4 (S16). Next, the store management server 1 starts recording use in the store of the IoT container 4 corresponding to the barcode (S17). For example, the store management server 1 records the lapse of time from the timing when use of the IoT container 4 is started. For example, since the barcode is not stored in the IoT container ID 131a of the container management table 131, the store management server 1 determines that it is the timing at which use of the IoT container 4 is started. The store management server 1 stores in the container management table 131 the barcode, the address corresponding to the barcode, “0” as the use time in association with each other. The store management server 1 activates the timer corresponding to the barcode, and records the lapse of time from the timing when use of the IoT container 4 is started.

On the other hand, the POS terminal 3 that has accepted the scan operation of the barcode on the mobile application screen acquires the barcode, and identifies the customer information indicating the visiting customer (S18). The POS terminal 3 performs settlement processing (S19). The POS terminal 3 transmits the acquired customer information to the store management server 1.

Upon accepting the customer information, the store management server 1 associates the customer information with the IoT container 4 whose use has been started (S20). For example, the store management server 1 stores the customer information in the visiting customer ID 131c corresponding to the IoT container ID 131a in the container management table 131.

Subsequently, the monitoring camera 2 and the IoT container 4 transmit the detection result (detection information) to the store management server 1 (S21, S22), and the acquisition unit 121 acquires the detection information detected by the monitoring camera 2 and the IoT container 4 (S23).

Next, the attribute determination unit 124 determines the reference group attribute to which the customer associated with the IoT container 4 belongs based on the situation around the IoT container 4 indicated by the acquired detection information. Next, the attribute impartation unit 126 imparts the determination result by the attribute determination unit 124 to the reference group attribute 132e in the customer management table 132 in association with the customer corresponding to the IoT container 4 (S24).

For details of the process of imparting the reference group attribute, a method of using a captured image of the IoT container 4 by the camera 45, a method of using short-distance wireless communication of the IoT container 4, and a method of using an image captured by the monitoring camera 2 are described.

### Method of Using Captured Image of IoT Container 4

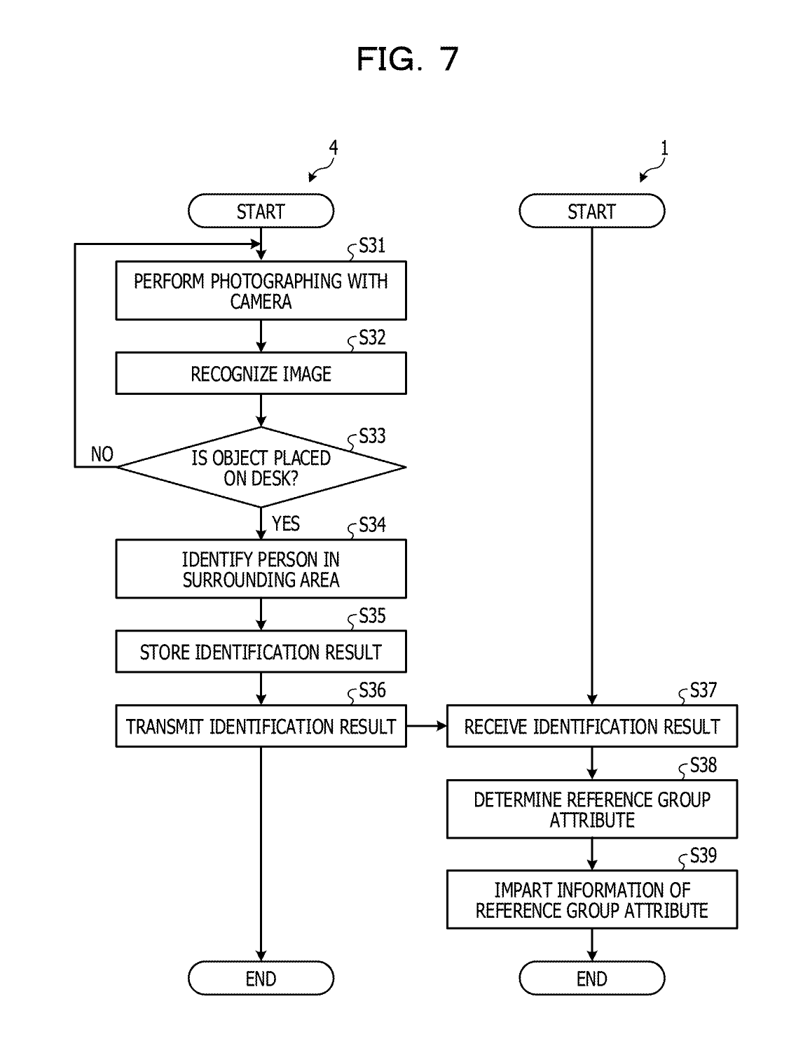

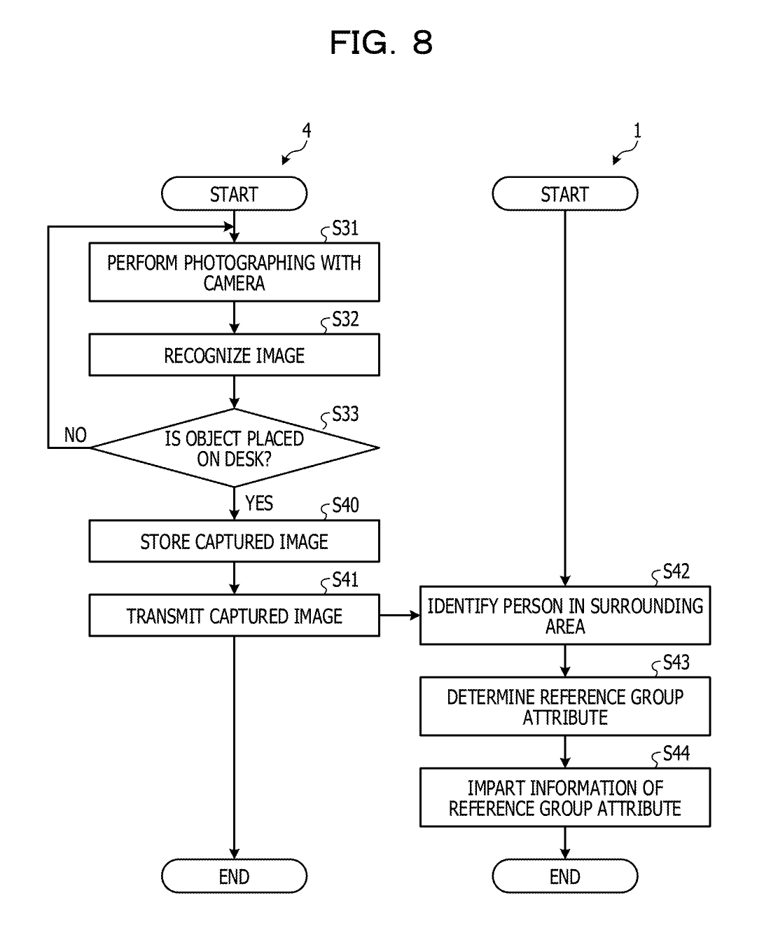

FIGS. 7 and 8 are flowcharts illustrating an example of a process of imparting the reference group attribute. For example, FIGS. 7 and 8 are flowcharts illustrating the process of imparting the reference group attribute by using the captured image of the IoT container 4.

As illustrated in FIG. 7, when the process is started, the IoT container 4 performs photographing with the camera 45 (S31). Next, the image recognition unit 44 performs image recognition of the image captured by the camera 45, and recognizes an object (table, person) included in the captured image (S32).

Next, the control unit 42 of the IoT container 4 determines whether the IoT container 4 is placed on a desk or the like based on the image recognition result by the image recognition unit 44 (S33). For example, the control unit 42 recognizes the table from the captured image, and determines that the IoT container 4 is placed on the desk when the state in which the movement of the subject based on the correlation between the frames has stopped continues for a predetermined time.

The sensor for determining whether the IoT container 4 is placed on the desk is not limited to a sensor using the camera 45. A motion sensor such as an acceleration sensor that detects the movement of the IoT container 4 may be used. In the configuration using the motion sensor, the control unit 42 may determines that the IoT container 4 is placed on the desk when the stop state continues for a predetermined time based on the detection value of the motion sensor. In this manner, the control unit 42 is an example of a detection unit.

When the IoT container 4 is not placed on the desk (“NO” in S33), the control unit 42 returns the process to S31. When the IoT container 4 is placed on the desk (“YES” in S33), the image recognition unit 44 identifies a person around the IoT container 4 based on the image captured by the camera 45 (S34).

For example, since the person around the IoT container 4 is detected as a person region having a size equal to or larger than a predetermined size in the captured image, the image recognition unit 44 specifies the person region having the size equal to or larger than the predetermined size from the captured image to analyze the specified person region. As a result, the image recognition unit 44, acquires the identification result of the person around the IoT container 4 such as the number of persons included in the person region, age and gender.

Next, the control unit 42 stores the identification result by the image recognition unit 44 in the storage unit 43 (S35), and transmits the stored identification result together with the identification information of the control unit itself (IoT container ID) to the store management server 1 via the communication unit 41 (S36).

The acquisition unit 121 of the store management server 1 receives the identification result transmitted from the IoT container 4 together with the identification information of the IoT container 4 (IoT container ID) (S37). Next, the attribute determination unit 124 determines the reference group attribute of the customer corresponding to the IoT container 4 based on the identification result transmitted from the IoT container 4, for example, the number of persons around the IoT container 4, age and gender (S38).

For example, the attribute determination unit 124 judges whether the combination condition of the number of persons around the IoT container 4, age and gender satisfies the condition preset for each of the reference groups (groups) such as “family” or “couple” to determine the reference group attribute. For example, in the case of a combination of a man and a woman of the same generation, it is determined that the reference group attribute is “couple”. In the case of a combination of a man and a woman in their 20's or older and a man or a woman in their 10's or younger, it is determined that the reference group attribute is “family”.

Next, the attribute impartation unit 126 imparts the attribute information of the determined reference group to the customer information of the customer corresponding to the IoT container 4 (S39). For example, the attribute impartation unit 126 refers to the container management table 131 and identifies the identification information of the customer (visiting customer ID) corresponding to the identification information (IoT container ID) coming from the IoT container 4. Next, the attribute impartation unit 126 imparts the determination result by the attribute determination unit 124 to the reference group attribute 132e in the customer management table 132 in association with the customer corresponding to the IoT container 4.

The captured image of the IoT container 4 may be used in the store management server 1. For example, as illustrated in FIG. 8, when the IoT container 4 is placed on the desk (“YES” in S33), the control unit 42 of the IoT container 4 stores the image captured by the camera 45 in the storage unit 43 (S40). Subsequently, the control unit 42 transmits the stored captured image together with its own identification information (IoT container ID) to the store management server 1 via the communication unit 41 (S41).

The acquisition unit 121 of the store management server 1 receives the captured image transmitted from the IoT container 4 together with the identification information of the IoT container 4 (IoT container ID). As in S34, the image recognition unit 125 of the store management server 1 identifies the person around the IoT container 4 based on the captured image of the IoT container 4 (S42).

Next, the attribute determination unit 124 determines the reference group attribute of the customer corresponding to the IoT container 4 based on the identification result by the image recognition unit 125, for example, the number of persons around the IoT container 4, age and gender (S43). Next, the attribute impartation unit 126 imparts the attribute information of the determined reference group to the customer information of the customer corresponding to the IoT container 4 (S44).

### Method of Using Short-Distance Wireless Communication of IoT Container 4

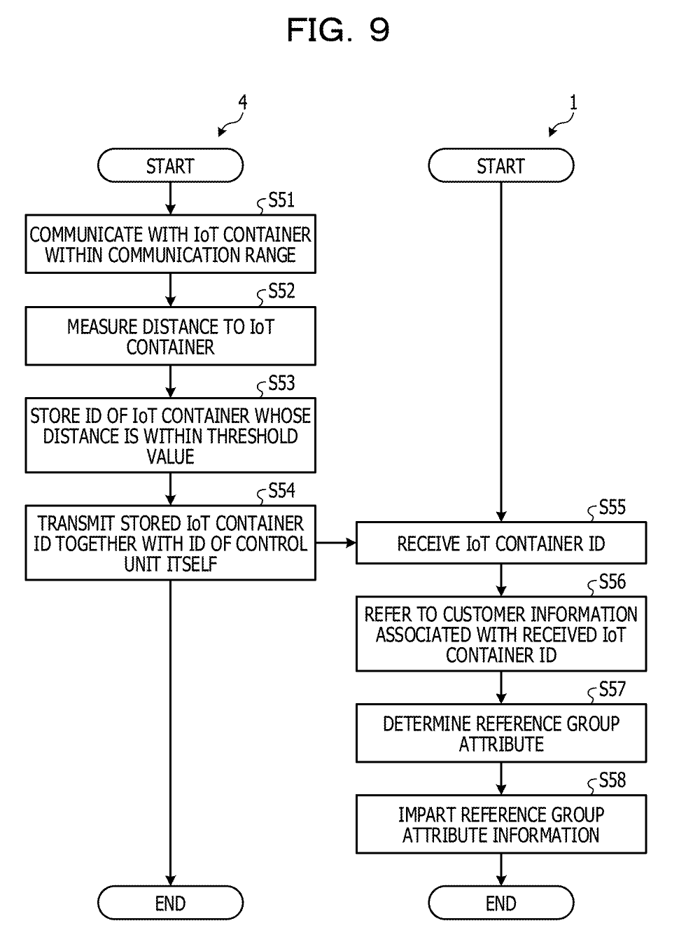

FIG. 9 is a flow chart illustrating an example of a process of imparting a reference group attribute. For example, FIG. 9 is a flowchart illustrating the process of imparting the reference group attribute using short-distance wireless communication of the IoT container 4.

As illustrated in FIG. 9, when the process is started, the communication unit 41 of the IoT container 4 communicates with one or more different IoT containers (hereinafter referred to as different IoT containers) within the communication range of the short-distance wireless communication (S51). Through this communication, the communication unit 41 acquires the radio wave intensity with respect to the different IoT containers and the identification information of the different IoT containers (IoT container IDs).

Next, the communication unit 41 measures the distances to the different IoT containers based on the radio wave intensity in the short-distance wireless communication (S52). Next, based on the measurement result in the communication unit 41, the control unit 42 stores in the storage unit 43 the IDs of the different IoT containers (IoT container IDs) whose distances are within a threshold value (for example, within several meters) (S53).

Thus, for example, the IDs of the IoT containers 4 of the customers who are seated at the same table are stored in the storage unit 43. In other words, when customers staying together are using the IoT containers 4, the IoT container IDs are stored in the storage unit 43 when they come close to each other such as when they are seated at the same table.

Next, the control unit 42 transmits the IDs of the different IoT containers (IoT container IDs) stored in the storage unit 43 together with its own ID (IoT container ID) to the store management server 1 via the communication unit 41 (S54).

The acquisition unit 121 of the store management server 1 receives the IoT container IDs (its own ID and the IDs of the different IoT containers) transmitted from the IoT container 4 (S55). Next, the attribute determination unit 124 refers to the container management table 131 and the customer management table 132 and refers to the customer information associated with the received IoT container IDs (S56).

For example, the attribute determination unit 124 refers to the container management table 131, and acquires the visiting customer ID associated with the received IoT container IDs. Next, the attribute determination unit 124 refers to the customer management table 132 based on the acquired visiting customer ID, and acquires customer information such as the name, the age, the gender, and so forth of the customer.

Next, the attribute determination unit 124 determines the reference group based on the customer information acquired by referring to the customer management table 132 (S57).

The combination of the IoT container IDs acquired from the IoT container 4 (its own ID and the IDs of the different IoT containers) may be regarded as corresponding to the customers who stay together. Therefore, the customer information acquired based on the IoT container IDs acquired from the IoT container 4 may be regarded as the customer information of the customers who stay together.

Therefore, in S57, the attribute determination unit 124 judges whether the combination condition of the acquired customer information (age, gender and so forth) satisfies a condition preset for each of the reference groups (groups) such as “family”, “couple” to determine the reference group attribute.

Next, the attribute impartation unit 126 imparts the attribute information of the determined reference group to the customer information of the customer corresponding to the IoT container 4 (S58).

### Method of Using Image Captured by Monitoring Camera 2

In the method of using the image captured by the monitoring camera 2, the IoT container 4 may not be provided with the detection function or the communication function. The IoT container 4 may be provided with a marker that may be identified by the monitoring camera 2.

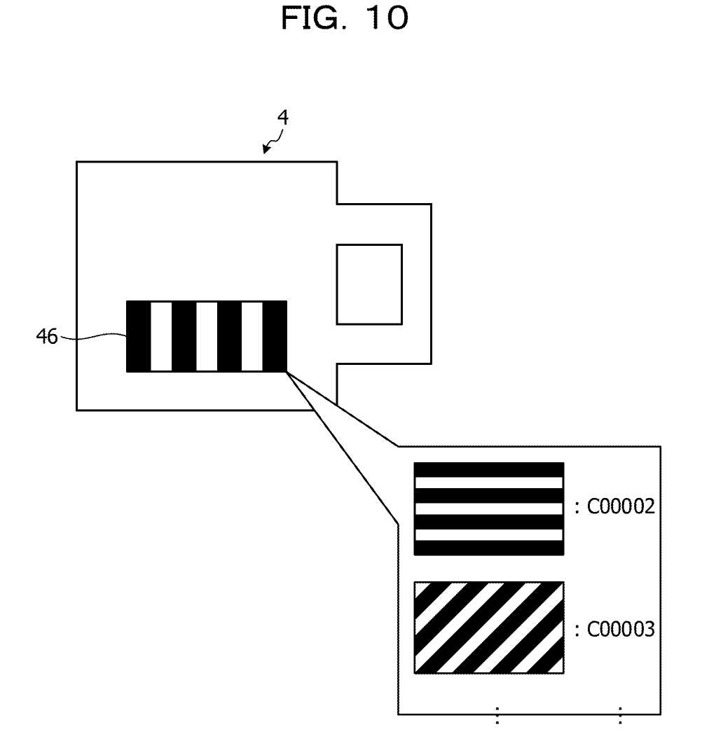

FIG. 10 is a diagram illustrating an example of a marker of the IoT container 4 according to the embodiment. As illustrated in FIG. 10, the IoT container 4 is provided with a marker 46 corresponding to the IoT container ID on, for example, a side surface. Thus, the image recognition unit 125 may identify the marker 46 of the IoT container 4 from the image captured by the monitoring camera 2, whereby the store management server 1 may identify the IoT container 4.

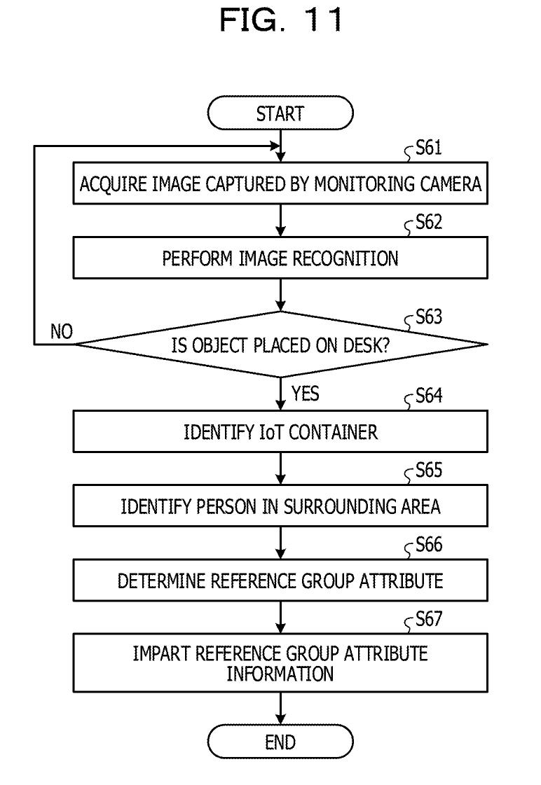

FIG. 11 is a flow chart illustrating an example of a process of imparting a reference group attribute. For example, FIG. 11 is a flowchart illustrating a process of imparting the reference group attribute by using the image captured by the monitoring camera 2.

As illustrated in FIG. 11, when the process is started, the acquisition unit 121 of the store management server 1 acquires the image captured by the monitoring camera 2 (S61). Next, the image recognition unit 125 performs image recognition of an object (person, thing) reflected in the captured image using a known image recognition technique (S62). Here, the IoT container 4 and the desk (table) are recognized from the image captured by the monitoring camera 2.

Next, based on the image recognition result, the image recognition unit 125 determines whether the IoT container 4 is placed on the desk (S63). For example, the image recognition unit 125 determines that the IoT container 4 is placed on the desk when the state in which the movement of the IoT container 4 on the desk has stopped continues for a predetermined time.

When the IoT container 4 is not placed on the desk (“NO” in S63), the image recognition unit 125 returns the processing to S61. When the IoT container 4 is placed on the desk (“YES” in S63), the image recognition unit 125 identifies the IoT container ID of the IoT container 4 based on the marker 46 of the IoT container 4 (S64).

Next, similarly to the image recognition by the image recognition unit 44, the image recognition unit 125 identifies a person around the IoT container 4 by image recognition of the captured image (S65). As a result, the store management server 1 acquires the identification result (the number of persons, age, gender, and so forth) of the persons around the IoT container 4.

Next, the attribute determination unit 124 determines the reference group attribute of the customer corresponding to the IoT container 4 based on the identification result by the image recognition unit 125, for example, the number of persons around the IoT container 4, age and gender (S66). Next, the attribute impartation unit 126 imparts the attribute information of the determined reference group to the customer information of the customer corresponding to the identified IoT container 4 (S67).

### Impartation of Reference Group Attribute

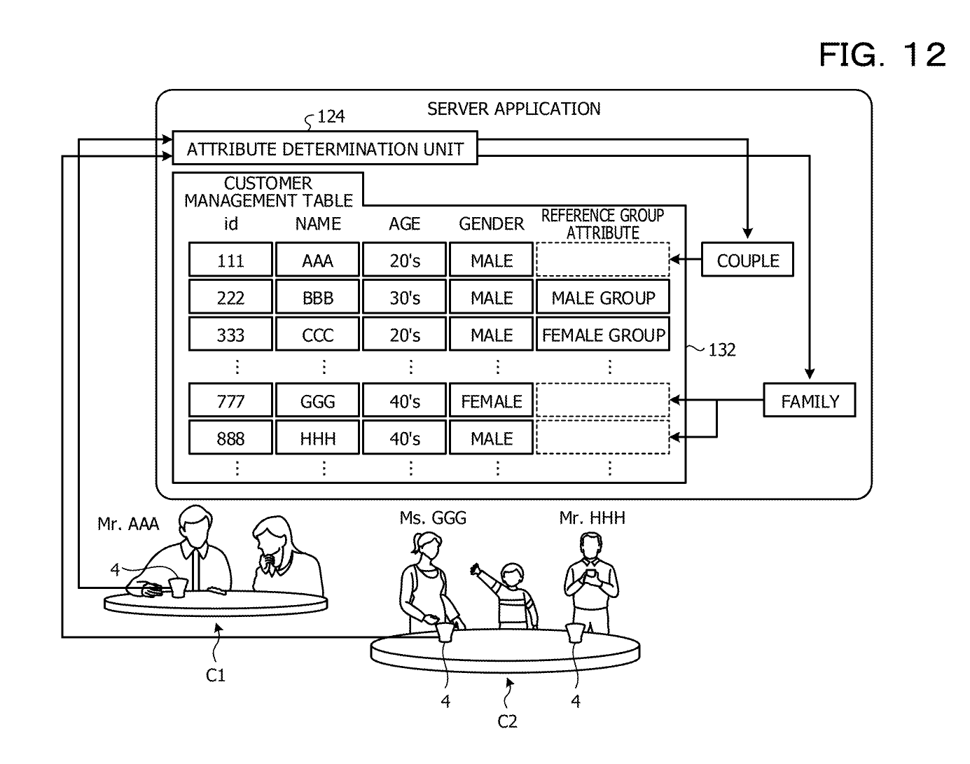

FIG. 12 is an explanatory diagram for describing the impartation of the reference group attribute. As illustrated in FIG. 12, the case C 1 represents a customer who is visiting the store as one of the couple, and “Mr. AAA” orders goods and uses the IoT container 4. The case C2 represents customers who are visiting the store as family members, and “Ms. GGG” and “Mr. HHH” both ordered the goods and use the IoT containers 4.

In the case C1, since “Mr. AAA” is present at the time of settlement. Although it is possible to collect attribute (name, age, gender) of “Mr. AAA”, it is difficult to collect information as to whether “Mr. AAA” is visiting the store as one of the couple. In the case C2, when “Ms. GGG” and “Mr. HHH” settle accounts separately at a checkout counter or the like, it is difficult to collect information indicating that the two are visiting the store as family members.

However, in either cases C1 and C2, the situation in which the IoT container 4 used by the customer is placed on the table represents, for example, a situation in which the customer is seated at the table. In such a situation, it is estimated that the customers who stay together, that is, members of the group of customers stay together.

Therefore, the attribute determination unit 124 determines the attribute of the group to which the customer associated with the IoT container 4 belongs based on the situation around the IoT container 4 when it is determined that the IoT container 4 is placed. As a result, in the store system 9, it is possible to collect the attribute of the group to which the customer belongs. For example, with the case C1, since a man and a woman of the same generation are present in the surrounding area, it may be determined that they are “couple”. With the case C2, since a man and a woman in their 20's or older (“Ms. GGG” and “Mr. HHH”), and a boy in his 10's or younger are present, it may be determined that they are “family”.

Returning to FIG. 6, following S24, the transmission unit 127 transmits a message to the destination corresponding to the customer according to the attribute information (couple, family . . . ) imparted to the reference group attribute 132e in the customer management table 132 with respect to the customer corresponding to the IoT container 4 (S25).

### Effects of Embodiments

As described above, in the store system 9, upon settling an account at the POS terminal 3 or the like, identification information of the customer (visiting customer ID 132a) and identification information of the IoT container 4 (IoT container ID 131a) used by the customer associated with the identification information of the customer are received. In the store system 9, it is determined whether the IoT container 4 is placed on the table using the sensor mounted on the IoT container 4. In the store system 9, when it is determined that the IoT container 4 is placed on the table, the situation around the IoT container 4 is specified by using a camera or a wireless device mounted on the IoT container 4. In the store system 9, based on the situation around the identified IoT container 4, the attribute of the group to which the customer associated with the IoT container 4 belongs is determined, and the determination result in association with the identification information of the customer is stored in the storage unit 13.

The situation in which the IoT container 4 used by the customer is placed on the table represents, for example, a situation in which the customer is seated at the table. Under such circumstances, it is estimated that the customers who behave together, that is, a group of the customers, stay together even when they settle accounts separately at a checkout counter or the like. Therefore, in the store system 9, it is possible to collect the attribute of the group to which the customer belongs by determining the group attribute to which the customer associated with the IoT container 4 belongs based on the situation around the IoT container 4 when it is determined that the IoT container 4 is placed on the table.

The IoT container 4 includes the camera 45, the storage unit 43, and the communication unit 41. The camera 45 images the periphery of the IoT container 4. The storage unit 43 stores captured image data around the IoT container 4 wherein the image data is captured by the camera 45 or attribute data of a person(s) acquired by analyzing a portrait image(s) of one or more persons detected from the captured image data. The communication unit 41 outputs the data stored in the storage unit 43 to the store management server 1. As a result, the store management server 1 of the store system 9 may collect the attribute of the group to which the customer belongs based on the data output from the IoT container 4.

The IoT container 4 detects that the IoT container 4 is placed on the table, and acquires captured image data using the camera 45 when it is detected that the IoT container 4 is placed on the table. As a result, the IoT container 4 may image the surrounding area, for example, when the customer is seated at the table or the like and the IoT container 4 is placed on a board such as a table, whereby it is possible to shoot another customer who is assumed to stay together.

The communication unit 41 of the IoT container 4 receives the identification information from one or more different IoT containers in the surrounding area. The storage unit 43 of the IoT container 4 stores identification information from one or more received different IoT containers. The communication unit 41 outputs the stored identification information to the store management server 1. As a result, the store management server 1 of the store system 9 may collect the attribute of the group to which the customer using the IoT container 4 belongs by using the identification information from one or more different IoT containers in the surrounding area wherein the identification information is output from the IoT container 4.

The store management server 1 includes the acquisition unit 121, the attribute determination unit 124, and the attribute impartation unit 126. The acquisition unit 121 acquires the captured image around the IoT container 4 stored in the storage unit 43 of the IoT container 4. The attribute determination unit 124 analyzes a portrait image(s) of one or more persons detected from the acquired captured image to acquire attribute data of the person(s). The attribute impartation unit 126 stores the feature extracted from the acquired attribute data of the person in the storage unit 13 in association with the user corresponding to the IoT container 4 in the customer management table 132. As a result, the store management server 1 may collect from the captured image around the IoT container 4 the attribute of the group to which the customer using the IoT container 4 belongs.

The acquisition unit 121 of the store management server 1 acquires attribute data of the person stored in the storage unit 43 of the IoT container 4, and the attribute impartation unit 126 of the store management server 1 may store the feature extracted from the acquired attribute data of the person in the storage unit 13 in association with the user corresponding to the IoT container 4. In this manner, the store management server 1 may collect the attribute of the group to which the customer using the IoT container 4 belongs by acquiring the attribute data of the person stored in the IoT container 4.

The transmission unit 127 of the store management server 1 transmits a message to the destination of the user corresponding to the IoT container 4 in accordance with the feature (reference group attribute 132e) stored in the storage unit 13. For example, the transmission unit 127 transmits to the user a message for couple such as a discount service targeting a couple when the reference group attribute 132e is “couple” (see case C1 in FIG. 12). The transmission unit 127 transmits a family oriented message such as a discount service for family the user when the reference group attribute 132e is “family” (see the case C2 in FIG. 12). In this manner, the store system 9 may provide a service which will be further satisfied by the customer by transmitting a message corresponding to the reference group attribute 132e of the user.

### Others

Each constituent element of each device illustrated in the drawings is not necessarily physically configured as illustrated in the drawings. In other words, concrete forms of distribution and integration of the units are not limited to those illustrated in the drawings, and all or part of the units may be configured to be functionally or physically distributed and integrated in any units depending on various loads and conditions in use.

All of or part of various processing functions of the store management server 1 and the IoT container 4 may be executed by a CPU (or a micro computer such as an MPU and a micro controller unit (MCU)). All of or part of Various processing functions may be naturally implemented on a program analyzed and executed by a CPU (or a micro computer such as an MPU and an MCU), or on hardware by a wired logic.

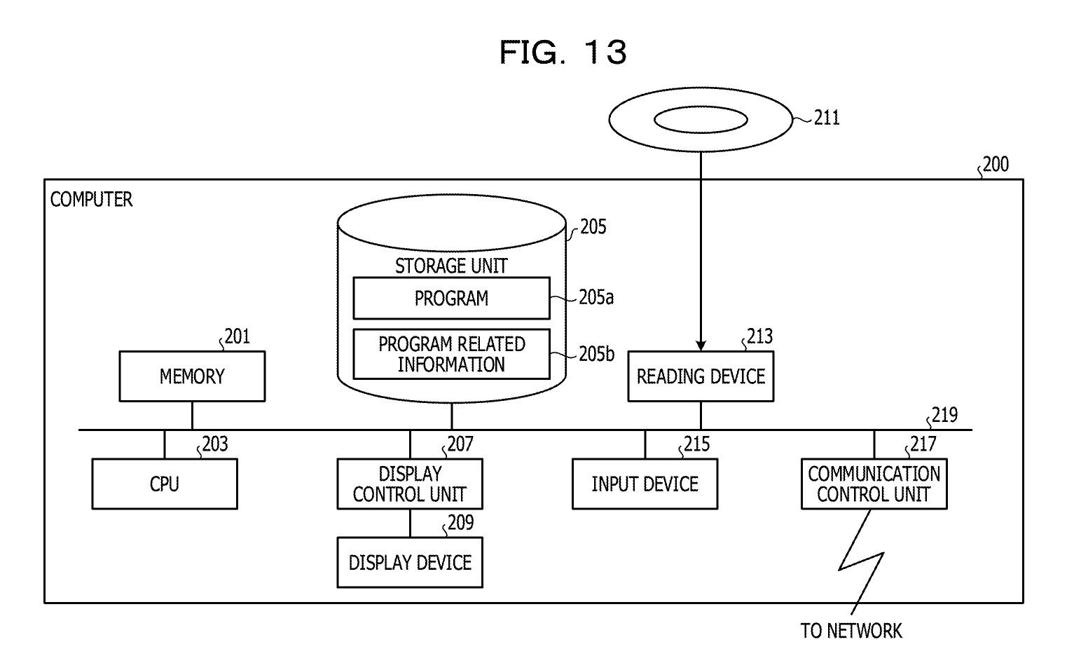

The various processes described in the above embodiments may be implemented by executing a program prepared in advance by a computer. In the following, an example of a computer (hardware) that executes a program having the same function as the above embodiment will be described. FIG. 13 is a diagram illustrating an example of a computer that executes a program.

As illustrated in FIG. 13, in a computer 200 includes a CPU 203 that executes various arithmetic processing, an input device 215 that accepts input of data from the user, and a display control unit 207 that controls a display device 209. The computer 200 includes a reading device 213 that reads a program or the like from a storage medium 211, and a communication control unit 217 that exchanges data with another computer via a network. The computer 200 includes a memory 201 that temporarily stores various pieces of information, and a storage device 205 such as an HDD. The memory 201, the CPU 203, the storage device 205, the display control unit 207, the reading device 213, the input device 215 and the communication control unit 217 are connected to each other by a bus 219.

The reading device 213 is a device for the storage medium 211 such as a removable disk or a semiconductor memory. The storage device 205 stores a program 205a (for example, a customer management program, a feature extraction program) related to various processing functions.

The CPU 203 reads the program 205a, develops it in the memory 201, and executes it as a process. This process corresponds to each functional unit of the store management server 1, the POS terminal 3 and the IoT container 4. Program related information 205b is information related to processing of the program 205a, and corresponds to the container management table 131, the customer management table 132, and so forth. For example, the storage medium 211 stores information such as the program 205a. The storage medium 211 includes, for example, a portable recording medium such as a CD-ROM, a DVD disk, or a universal serial bus (USB) memory, a semiconductor memory such as a flash memory, a hard disk drive, or the like.

The program 205a does not necessarily have to be stored in the storage device 205 in advance. For example, the program 205a may be stored in a portable physical medium, which is the storage medium 211 to be inserted into the computer 200. The computer 200 may read the program 205a from the storage medium 211 to execute the program 205a. The program 205a may be stored in a device connected to a public line, the Internet, a LAN, or the like, and the computer 200 may read the program 205a from the device to execute the program 205a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A container comprising:
a sensor configured to output a signal regarding a situation around the container;
a memory; and
a processor coupled to the memory, the processor being configured to
execute a recognition process that includes recognizing the situation around the container in accordance with the signal from the sensor,
execute a determination process that includes determining, in accordance with a result of the recognition, a group attribute to which one or more persons around the container belong,
execute a registration process that includes registering the group attribute to the memory associatively with the container.

2. The container according to claim 1,
wherein the sensor is a camera configured to capture a periphery of the container,
wherein the recognition process is configured to recognize the situation around the container by performing an image recognition on an image captured by the camera.

3. The container according to claim 1,
wherein the sensor is wireless communication circuitry configured to receive a radio signal that represents an image captured by a camera,
wherein the recognition process is configured to recognize the situation around the container by performing an image recognition on the image represented by the radio signal.

4. The container according to claim 1,
wherein the sensor is wireless communication circuitry configured to receive a radio signal that represents an identification code associated with the group attribute to which one or more persons around the container belong,
wherein the determination process is configured to determine the group attribute in accordance with the radio signal received by the wireless communication circuitry.

5. A non-transitory computer-readable storage medium for storing a program which causes a processor to perform processing for internet of things (IoT), the processing comprising:
executing a recognition process that includes recognizing a situation around a container in accordance with the signal from a sensor, the sensor being configured to output the signal regarding the situation around the container,
executing a determination process that includes determining, in accordance with a result of the recognition, a group attribute to which one or more persons around the container belong,
executing a registration process that includes registering the group attribute to a memory associatively with the container.

6. The non-transitory computer-readable storage medium according to claim 5,
wherein the sensor is a camera configured to capture a periphery of the container,
wherein the recognition process is configured to recognize the situation around the container by performing an image recognition on an image captured by the camera.

7. The non-transitory computer-readable storage medium according to claim 5,
wherein the sensor is wireless communication circuitry configured to receive a radio signal that represents an image captured by a camera,
wherein the recognition process is configured to recognize the situation around the container by performing an image recognition on the image represented by the radio signal.

8. The non-transitory computer-readable storage medium according to claim 5,
wherein the sensor is wireless communication circuitry configured to receive a radio signal that represents an identification code associated with the group attribute to which one or more persons around the container belong,
wherein the determination process is configured to determine the group attribute in accordance with the radio signal received by the wireless communication circuitry.

9. A method for customer management, the method comprising:
executing, performed by processor circuitry of a computer, a recognition process that includes recognizing a situation around a container in accordance with the signal from a sensor, the sensor being configured to output the signal regarding the situation around the container,
executing, performed by the processor circuitry of the computer, a determination process that includes determining, in accordance with a result of the recognition, a group attribute to which one or more persons around the container belong,
executing, performed by the processor circuitry of the computer, a registration process that includes registering the group attribute to a memory associatively with the container.

10. The method according to claim 9,
wherein the sensor is a camera configured to capture a periphery of the container,
wherein the recognition process is configured to recognize the situation around the container by performing an image recognition on an image captured by the camera.

11. The method according to claim 9,
wherein the sensor is wireless communication circuitry configured to receive a radio signal that represents an image captured by a camera,
wherein the recognition process is configured to recognize the situation around the container by performing an image recognition on the image represented by the radio signal.

12. The method according to claim 9,
wherein the sensor is wireless communication circuitry configured to receive a radio signal that represents an identification code associated with the group attribute to which one or more persons around the container belong,
wherein the determination process is configured to determine the group attribute in accordance with the radio signal received by the wireless communication circuitry.
